(19) United States
(12) Patent Application Publication
(10) Pub. No.: US 2014/0079342 A1
(43) Pub. Date: Mar. 20, 2014

(54) PACKAGE, METHOD FOR MANUFACTURING A PACKAGE, AND USE OF SUCH PACKAGE

(71) Applicant: Mauro Kiiskinen, Trelleborg (SE)

(72) Inventor: Mauro Kiiskinen, Trelleborg (SE)

(73) Assignee: Gambro Lundia AB, Lund (SE)

(21) Appl. No.: 14/114,612

(22) PCT Filed: Apr. 17, 2012
(86) PCT No.: PCT/EP2012/057006

§ 371 Date: Oct. 29, 2013

Related U.S. Application Data
(60) Provisional application No. 61/480,389, filed on Apr. 29, 2011.

(30) Foreign Application Priority Data
Apr. 29, 2011 (SE) 1150374-5

(51) Int. Cl. B65D 33/18; B65B 7/02; B31B 1/90; B31B 1/62; B31B 1/64

(52) U.S. Cl. CPC B65D 33/18; B31B 1/62; B31B 1/64; B31B 1/90; B65B 7/02
USPC 383/35; 383/67; 493/189; 493/243; 493/264; 53/480

(57) ABSTRACT

A package including at least a first and a second side wall bonded to each other along at least one seam line forming a bond. The bond is peelable along at least a portion of the seam line. A first grip portion is formed on the first side wall, formed by a first folded-over portion of the first side wall folded along a first fold line and a second fold line. The first folded-over portion includes three layers of the first side wall, and all layers in the first folded-over portion are included in the bond.

### TECHNICAL FIELD OF THE INVENTION

The present invention relates to a package comprising at least a first and a second side wall bonded to each other along at least one seam line, said bond being peelable along at least a portion of said seam line, wherein a first grip portion is formed on the first side wall. The present invention also relates to a method for manufacturing a package. The invention further relates to the use of an inventive package as outer protective package for a container containing a medical solution.

### BACKGROUND ART

Various packages are known. One type of package is made up of two or more side walls that are bonded to each other. Along at least a part of the seam line between the side walls the seam is peelable, such that the package may be opened by gripping a flap of each side wall and pulling these flaps apart. Packages of this type are possible to open without the use of tools, such as scissors or a knife. One example of such a package is disclosed in U.S. Pat. No. 2,189,174, and another example is disclosed in EP 0 666 223 A1. A general problem with this type of package is that it is difficult to get a sufficiently secure grip of the flaps to be able to pull the seam open. This is especially difficult if the hands of the person opening the package are moist or oily. People suffering from rheumatism or arthritis may have particular trouble opening this type of package. The force required for opening the package has to be sufficiently high to prevent accidental opening of the package when transported and handled.

A particular problem with this kind of package arises in cases where the package is used for storing medical supplies, such as containers of medical solutions. In these cases, the package will often need to be sterilised, and some kinds of package material becomes harder when sterilised, thereby making edges of the package sharp. The package may therefore become uncomfortable to handle and open.

### SUMMARY OF THE INVENTION

It is an object of the invention to solve or alleviate the above-mentioned problems.

A particular object of the invention is to provide a package that is easy to open.

A further object is to provide a package which is practical and comfortable to handle.

Yet another object is to provide a package that is easy to lift.

It is also an object of the invention to provide a method for manufacturing a package, which is easy to open.

Another object is to provide a method for manufacturing a package that is practical and comfortable to handle and easy to lift.

A particular object is to provide a practical outer protective package for a container containing a medical solution.

These objects are achieved, in full or at least in part, by a package according to claim 1, with preferred embodiments defined by the dependent claims 2-8.

These objects are also achieved, in full or at least in part, by a method for manufacturing a package as defined in claim 9. Preferred variants thereof are defined in dependent claims 10-16.

These objects are also achieved by a use as defined in claim 17.

According to the invention, the first grip portion is formed by a first folded-over portion of the first side wall folded along a first fold line and a second fold line, said first folded-over portion containing three layers of the first side wall and all layers in the first folded-over portion being included in the bond. In this manner a grip portion is achieved which enables a secure grip for opening the package. If the folding is done with sufficient distance between the first fold line and the second fold line even the whole hand may be used for gripping, thereby enabling a particularly secure grip. When gripping the grip portion, the fingers encounter a fold in the side wall material instead of an edge of the side wall material, making gripping more comfortable and reducing the risk of cuts. Further, the grip portion may be used for lifting the package.

In an embodiment of the package, a second grip portion is formed on the second side wall by a second folded-over portion of the second side wall folded along a third fold line and a fourth fold line, said second folded-over portion containing three layers of the second side wall and all layers in the second folded-over portion being included in the bond, and wherein the first and second folded-over portions are folded in the same direction. If such grip portions are formed on both sides of the package, it becomes easy to open also packages containing contents that cannot themselves be used for gripping when opening the package. With grip portions on two side walls it is also easy and comfortable to lift the package, even if the contents are heavy or unstable.

The first and second folded-over portions may be juxtaposed. This means that the grip portions may be placed directly opposite each other. Such symmetry of the grip portions may simplify opening and lifting of the package.

Alternatively, the first and second folded-over portions may be staggered. In this manner, it is possible to avoid having to form a bond between the side walls which locally includes six layers of side wall material. If the folded-over portions are staggered, i.e. not placed directly opposite each other, only four layers of side wall material need to be included in the bond in each grip portion area, three layers of the side wall with the folded-over portion and one layer of the other side wall.

The fold lines may be parallel. This is generally the simplest way of folding and in many cases provides the most stable gripping position.

In a particular embodiment, the package is rectangular, and the fold lines are parallel to a pair of edges of the package. This is a simple, straight-forward construction of a package that is suitable for holding many kinds of contents.

The side walls may be made of plastic material. Many plastic materials are available which may enable simple production, durability and appealing appearance of the package.

The first and second side wall may be bonded to each other by heat sealing, high frequency (ultra sonic, radio frequency) welding, laser welding or adhesive agent. These are well known techniques for bonding materials to each other. The bonding of the first and second side walls may be direct, i.e. with the first and second side walls placed in direct contact with each other, or indirect, i.e. with a third or more side walls arranged between the first and second side walls.

According to the invention the method for manufacturing a package, comprises the steps of:
providing a first side wall having in inside and an outside,
providing a second side wall having an inside and an outside,
folding said first side wall in a first direction along a first fold line and in a second direction along a second fold line, said first and second fold lines being spaced apart, such that a first folded-over portion is formed, said first folded-over portion containing three layers of the first side wall,
placing the first and second side walls with their insides facing each other,
bonding said first and second side walls to each other along at least one seam line, such that a bond thereby formed is peelable along at least a portion of said seam line, and such that said first folded-over portions is included in the bond. With this method it is possible to obtain a package that is easy to open by providing grip portions that may be securely gripped. It is also possible to obtain a package that is more comfortable to open, since the fingers do not have to be in direct contact with an edge of the side wall material for opening, but instead contact a fold in the side wall material. The method further makes it possible to obtain a package that can be lifted easily.

In a variant, the method may further comprise the step of:
folding said second side wall in a third direction along a third fold line and in a fourth direction along a fourth fold line, said third and fourth fold lines being spaced apart, such that a second folded-over portion is formed, said second folded-over portion containing three layers of the second side wall,
wherein in the step of placing, the first and second side walls are oriented such that a first pocket formed by the first folded-over portion on the outside of the first side wall and a second pocket formed by the second folded-over portion on the outside of the second side wall open in the same direction, and
wherein in the step of bonding, the second folded-over portion is included in the bond. In this manner a package may be obtained which is particularly easy to open by providing a comfortable grip portion on either side of the package. A package obtainable by this method is also particularly easy to lift.

In the step of placing the first and second side walls the first folded-over portion and the second folded-over portion may be juxtaposed. As mentioned in relation to the inventive package this provides advantageous symmetry.

Alternatively, in the step of placing the first and second side walls the first and second folded-over portion may be staggered, thereby reducing the number of layers to include in the bond.

The first and second side walls may be made of plastic material. There are numerous plastic materials that may be chosen depending on what is to be contained in the package. Plastic materials also offer a wide choice of materials, which are easily workable, and which provide durability and appealing appearance to the package.

The bonding may be done by heat sealing, high frequency (ultra sonic, radio frequency) welding, lacer welding or adhesive agent, which are well known processes.

The choice of plastic material and the choice of bonding may be done in a way that the bonding of the folded over portion, with the outside of each side wall being aligned in the folding during the bonding, provides a permanent bonding, while the inside of the first and second side walls form a peelable seal.

The folding may be done such that the fold lines are parallel, thereby simplifying the folding process.

In a variant of the method, in the step of placing the first and second side walls the first fold line of the first side wall is placed in parallel with the third fold line of the second side wall. This makes it possible to achieve an advantageous symmetry of the grip portions formed.

According to the invention use of an inventive package is made as outer protective package for a container containing a medical solution. A package of the invention is particularly advantageous for use as outer protective package for containers containing medical solutions, since these often place strict requirements on the choice of materials and since they often need to be sterilised, thereby in many cases making the edges of the side walls hard and sharp. A package according to the invention makes it possible to open the package easily by providing a secure grip of the grip portion. This is of particular interest in hospitals and clinics where often a large number of packages need to be opened every day, and where the working pace may often be very high or even stressful. In many cases, the hands of the person opening the package may be wet, thereby making it difficult to achieve a secure grip for lifting or opening the package. With the inventive package this problem is alleviated. Further, the package of the invention is easy to lift securely, thereby reducing the risk of dropping the package or acquiring occupational injuries.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

As used herein, the term “bond” refers to a connection which is sufficiently resistant to the forces that occur during transport and handling of the package. When the side walls are bonded, this bond should be able to resist also forces occurring when the package is, e.g., accidentally dropped on the floor, without the seam opening.

When reference is being made to a folded-over portion being “included in the bond” this means that the side wall is folded over also in the area of the bond. Thus, in this area, the bond will include three layers of each folded side wall.

Further, the term “peelable” means that the seam is possible to open by hand, without tools. It is to be understood that if a bond is peelable it is the actual bond in the seam that opens, and that it is not the material surrounding the seam that rips apart.

### BRIEF DESCRIPTION OF THE DRAWINGS

The invention will be described in more detail with reference to the appended schematic drawings, which show an example of a presently preferred embodiment of the invention.

FIG. 1 is a perspective view of a package according to an embodiment of the invention with an inner container enclosed in the package.

FIG. 2 is a cross-sectional view of a package according to an embodiment of the invention.

FIG. 3 is a cross-sectional view of a package according to another embodiment of the invention.

FIG. 4 is a cross-sectional view of a package according to another embodiment of the invention.

FIG. 5 is a perspective view of the package of FIGS. 1 and 2 with the seam partially opened.

FIG. 6 is a perspective view of the package of FIG. 4 during opening.

### DETAILED DESCRIPTION OF PREFERRED EMBODIMENTS OF THE INVENTION

In the following, the invention will be described in connection with use as an outer protective package for a container containing a medical solution. However, as will be readily recognized by the skilled person, the possible uses for a package according to the invention are in no way limited to this particular example, as will be discussed later on.

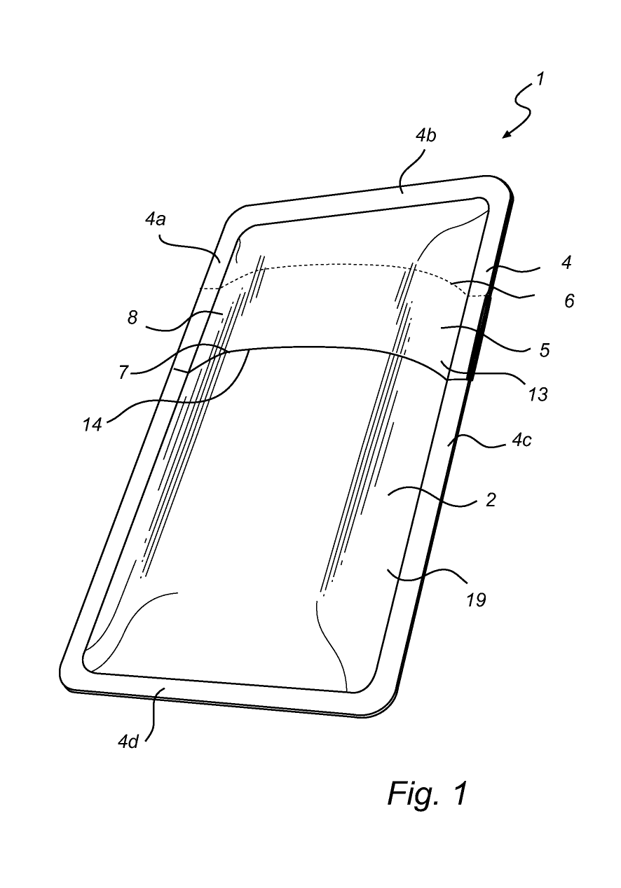

In FIG. 1, a package 1 according to an embodiment of the invention is shown. This package 1 has the general form of a bag, with two side walls 2, 3. Here, the side walls are formed by separate sheets forming a first side wall 2 and a second side wall 3. The side walls 2, 3 are bonded to each other along four seam lines 4. The side walls 2, 3 are made of transparent, plastic material and the bond is done by heat sealing. The heat sealing is, in manner known per se, done such that the bond between the two side walls 2 and 3 is peelable.

On the first side wall 2 a first folded-over portion 5 is formed by the first side-wall 2 being folded along a first fold line 6 and along a second fold line 7. By this folding a first grip portion 8 is formed. The folded-over portion 5 extends across the entire width of the first side wall 2, such that it is included in the bond at two opposing seam lines 4a, 4c.

Similarly, on the second side wall 3 a second folded-over portion 9 is formed by the second side wall 3 being folded along a third fold line 10 and a fourth fold line 11. This folding forms a second grip portion 12. The first folded-over portion 5 on the first side wall 2 is placed opposite the second folded-over portion 9 on the second side wall 3.

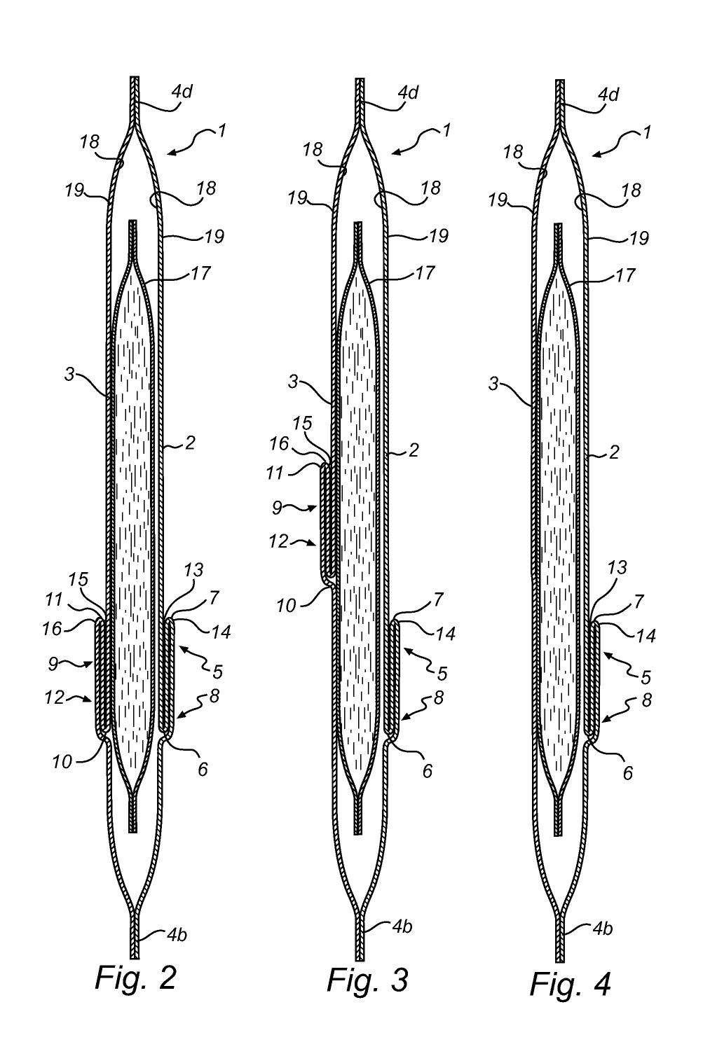

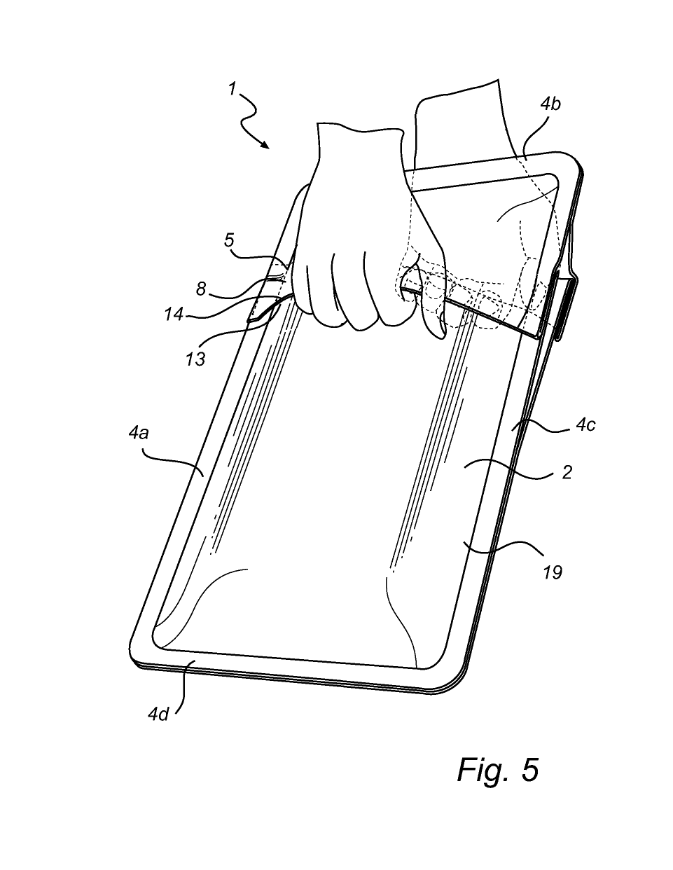

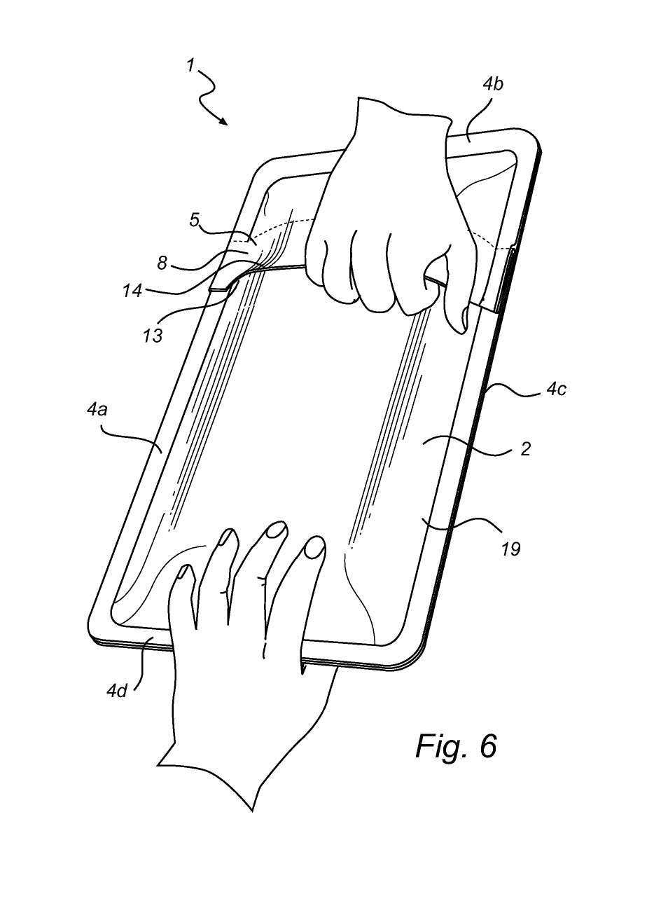

As may be seen more clearly in FIGS. 2, 3 and 4, the first folded-over portion 5 forms a first pocket 13, which is closed along the seam lines 4a, 4c and along the first fold line 6, and which has one open edge 14. In the same way, as may be seen more clearly in FIGS. 2 and 3, the second folded-over portion 9 forms a second pocket 15, which is closed along the seam lines 4a, 4c and along the third fold line 10, and which has one open edge 16. The folded-over portions 5, 9 are oriented such that the first pocket 13 and the second pocket 15 open in the same direction.

When manufacturing the package 1 two sheets are provided, one for the first side wall 2 and one for the second side wall 3. Each side wall 2, 3 has an inside 18 and an outside 19. The first side wall 2 is folded in the first direction along the first fold line 6 and then in a second direction along the second fold line 7. Optionally, the second side wall 3 is folded in a third direction along the third fold line 10 and then in a fourth direction along the fourth fold line 11. The first and second side walls are placed with their respective insides 18 facing each other. The first pocket 13 and the optional second pocket 15 formed by the folding are oriented such that they both have the open edges 14, 16 in the same direction. The side walls 2, 3 are bonded together along their edges through heat sealing. When sealing the side walls together, the folded-over portion 5 and optional folded-over portion 9 are included in the bond. If the folded-over portions 5, 9 are juxtaposed, the bond will in the area of the grip portions 8, 12 include six layers of side wall material (FIG. 2). If, instead, the folded-over portions 5, 9 are staggered, the bond will in the areas of the respective grip portions 8, 12 include four layers of side wall material (FIG. 3), three layers of the side wall with the folded-over portion and one layer of the other side wall.

The package 1 encloses an inner container 17, which in this specific example is a bag containing a dialysis fluid. The package 1 thus protects the inner container 17 from soiling and external forces, such as abrasive wear. If the inner container 17 has connectors, these may be placed such that they are covered by the folded-over portions 5, 9, thereby affording additional protection for these fragile parts.

When the contents of the inner container 17 are to be used, the package 1 may be lifted using the grip portions 8, 12. The person lifting the package 1 inserts the fingers of his/her hand in the first pocket 13 or the second pocket 15, depending on which side wall faces upwards, and can thereby lift the package 1 securely. If the distance between the fold lines of the respective folded-over portion is large enough, also part of the palm of the hand may be inserted in the pocket, thereby ensuring an even more secure grip. With the grip portions 8, 12 placed only a short distance from one of the ends of the package 1 lifting is particularly stable.

Before using the contents of the inner container 17, the outer package 1 needs to be removed. The person opening the package 1 inserts the fingers of his/her right hand in the first pocket 13, and the fingers of his/her left hand in the second pocket 15. In the same way as when lifting the package 1, a larger part of the hand may be used for gripping if the pockets 13, 15 are deep enough, i.e. if the distance between the fold lines of the respective folded-over portion is large enough. By pulling the grip portions 8, 12 apart, the bond between the insides of the first and second side wall 2, 3 may be peeled open along at least part of the seam line 4. In an embodiment of the package 1, at least three seam lines 4a-c are peeled open, thereby creating easy access to the inner container 17.

The skilled person realises that a number of modifications of the embodiments described herein are possible without departing from the scope of the invention, which is defined in the appended claims.

For instance, there need not necessarily be a folded-over portion on the second side wall 3. For products enclosed in the package that may themselves serve as a sort of grip portion it is sufficient if only the first side wall 2 has a grip portion 8. Such a package with only one folded-over portion may be used for products that are sufficiently rigid and/or robust that they may be gripped trough the second side wall 3 and serve as a grip portion when opening the package. This may be the case for rigid inner containers, but also for products contained directly in the package, without an inner container. An example of the latter type of products is food stuffs such as hard cheese.

In the embodiments shown in the drawings, the package is made up of two separate sheets. The invention is, however, not limited to this. Instead, a single sheet may be folded and serve as both the first side wall and the second side wall. In such case, there would only be a need for seam lines along three edges of the package.

Further, the bonding of the first and second side walls need not be direct. A third side wall may be interposed between the first and second side walls at one side of the package, whereas a fourth side wall may be interposed between the first and second side walls at the other side of the package. The first and second side walls would then be bonded to each other indirectly, via the third and fourth side walls. Still, in embodiments with two grip portions, the grip portions may be placed on opposite side walls, in this case the first and second side walls, in order to create a symmetry that simplifies lifting and opening. Naturally, any number of side walls more than two may be used.

In the embodiments shown in the drawings the folded-over portions are placed a short distance from one end of the package. However, other positions for the folded-over portions are also possible. For instance, the folded over-portions may be placed at the very edge of the side walls. Alternatively, the folded-over portions may be placed near the centre of the package.

In the drawings, the package 1 is rectangular and the folded-over portion parallel to the two shorter sides of the rectangle. However, the folded-over portion may instead extend parallel to the two longer sides. Further, the folded-over portion may extend generally diagonally from one of the shorter sides to one of the longer sides, e.g. close to one of the corners. The package may also have any other shape, such as square, triangular or circular.

Above, the bonding has been described as being done by heat sealing. It may also be done by high frequency (ultra sonic, radio frequency) welding, laser welding or adhesive agent or any other method chosen with consideration of the side wall material. The bond need not necessarily be peelable along all the seam lines or along the entire seam lines, as long as the peelable portion of the seam line is sufficiently large to allow easy extraction of the contents of the package.

The material of the side walls is in the embodiment described above plastic, but may be, e.g., a metallic foil laminated with plastic or a laminate. The material should be chosen in view of the properties required for the specific contents to be enclosed in the package. For medical uses, the material in many cases needs to be sterilisable. If the package is to be used as outer protective package for a container containing a dialysis fluid or dialysis concentrate containing bicarbonate, the side wall material needs to be a barrier against carbon dioxide, such that the pH of the fluid is maintained. Generally, polyolefines will be used. A number of different multi-layer materials are available, as well as materials containing silicon oxide or ethyl vinyl alcohol (EVOH). If the contents to be enclosed in the package are intended for medical use, the side wall material needs to be medical grade. Similarly, if the contents for which the package is intended is food, the side wall material needs to be approved for use with food stuffs. Other requirements may apply for other uses.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and the scope of the appended claims.

1. A package comprising:
at least a first and a second side wall bonded to each other along at least one seam line forming a bond, said bond being peelable along at least a portion of said seam line, and
a first grip portion is formed on the first side wall, wherein the first grip portion is formed by a first folded-over portion of the first side wall folded along a first fold line and a second fold line, said first folded-over portion includes three layers of the first side wall and all layers in said first folded-over portion are included in the bond.

2. A package as claimed in claim 1, wherein a second grip portion is formed on the second side wall by a second folded-over portion of the second side wall folded along a third fold line and a fourth fold line, said second folded-over portion includes three layers of the second side wall and the three layers in said second folded-over portion are included in the bond, and wherein the first and second folded-over portions are folded in the same direction.

3. A package as claimed in claim 2, wherein the first and second folded-over portions are juxtaposed.

4. A package as claimed in claim 2, wherein the first and second folded-over portions are staggered.

5. A package as claimed in claim 2, wherein the first, second, third and fourth fold lines are parallel.

6. A package as claimed in claim 5, said package being rectangular, and said first, second, third and fourth fold lines are parallel to opposite edges of the package.

7. A package as claimed in claim 1, wherein the side walls are made of plastic material.

8. A package as claimed in claim 1, wherein the first and second side wall are bonded to each other by heat sealing, high frequency (ultra sonic, radio frequency) welding, laser welding or adhesive agent.

9. A method for manufacturing a package, comprising:
providing a first side wall having an inside and an outside,
providing a second side wall having an inside and an outside,
folding said first side wall in a first direction along a first fold line and in a second direction along a second fold line, said first and second fold lines being spaced apart, such that a first folded-over portion is formed, said first folded-over portion containing three layers of the first side wall,
placing the first and second side walls with their insides facing each other, and
bonding said first and second side walls to each other along at least one seam line, such that a bond thereby formed is peelable along at least a portion of said seam line, and such that said first folded-over portion is included in the bond.

10. A method as claimed in claim 9, further comprising:
folding said second side wall in a third direction along a third fold line and in a fourth direction along a fourth fold line, said third and fourth fold lines being spaced apart, such that a second folded-over portion is formed, said second folded-over portion containing three layers of the second side wall,
wherein in the step of placing, the first and second side walls are oriented such that a first pocket formed by the first folded-over portion on the outside of the first side wall and a second pocket formed by the second folded-over portion on the outside of the second side wall open in the same direction, and
wherein in the step of bonding, the second folded-over portion is included in the bond.

11. A method as claimed in claim 10, wherein in the step of placing the first and second side walls the first folded-over portion and the second folded-over portion are juxtaposed.

12. A method as claimed in claim 10, wherein in the step of placing the first and second side walls the first and second folded-over portions are staggered.

13. A method as claimed in claim 9, wherein the first and second side walls are made of plastic material.

14. A method as claimed in claim 9, wherein said bonding is done by at least one of heat sealing; high frequency, ultra sonic or radio frequency welding; laser welding and an adhesive agent.

15. A method as claimed in claim 9, wherein the folding is done such that the fold lines are parallel.

16. A method as claimed in claim 10, wherein in the step of placing the first and second side walls, the first fold line of the first side wall is placed in parallel with the third fold line of the second side wall.

17. (canceled)

18. A package comprising:
a first side wall and a second side wall adjacent to the first side wall;
a peelable bond formed between the first side wall and the second side wall and aligned with a seam line between the first side wall and the second side wall, and
a grip including a first folded-over portion of the first side wall folded along both a first fold line and a second fold line, the first folded-over portion includes three layers of the first side wall, wherein the seam line and peelable bond extend through the first folded-over portion.

19. The package of claim 18 wherein the first fold line and the second fold line are transverse to the seam line.

20. The package of claim 18 further wherein the grip is adjacent an portion of the first side wall overlapped by the first-folded over portion.

21. The package of claim 18 further comprising a pocket between the first-folded over portion and an overlapped portion of the first sidewall overlapped by the first-folded over portion.

22. The package of claim 18 wherein the seam line includes a first seam line and a second seam line on opposite sides of the first and second side walls, and the peelable bond includes a first peelable bond aligned with the first seam line and a second peelable bond aligned with the second seam line, and the first and second seam lines and peelable bonds extend through the first folded-over portion.

23. A method to seal a package comprising:
forming a folded-over portion of a first side wall by folding the first sidewall in a first direction along a first fold line and in a second direction along a second fold line spaced from the first fold line, wherein the folded-over portion includes three layers of the first side wall and forms a grip adjacent a portion of the first side wall overlapped by the folded-over portion, and
bonding a second sidewall to the first sidewall to form a cavity between the first and second sidewalls, wherein the bonding includes a peelable bond along a seam line between the first and second sidewalls, and the peelable bond and seam line extend through the folded-over portion of the first sidewall.
